(19) United States
(12) Patent Application Publication
(10) Pub. No.: US 2006/0101460 A1
(43) Pub. Date: May 11, 2006

(54) Method and systems for integrating software distribution

(75) Inventor: Tzu-Pei Chen, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/037,895

(22) Filed: Jan. 18, 2005

(30) Foreign Application Priority Data
Nov. 8, 2004 (TW) 93124014

(51) Int. Cl. G06F 9/445

(52) U.S. Cl. 717/174

(57) ABSTRACT

A method for integrating software distribution. A main execution file and a plurality of shared distribution systems are packaged as a main installation program. The main installation program accesses an installation configuration file, registering the number of installation components and installation sequences corresponding to each installation component. The main installation program installs the shared distribution systems and a component execution file in an installation component according to one installation sequence.

### BACKGROUND

The invention relates to software installation procedures, especially to methods and systems for integrating software distribution.

FIG. 1 is a flowchart of a design process for software installation.

In step S11, software distribution and corresponding required installation components and sequences are created.

In step S12, installation flow control is defined, ensuring installation processes and settings are correctly set.

In step S13, dynamic link library (DLL) files are designed for specified software or devices or derived from a pre-defined DLL database.

In step S14, the software distributions is verified to assure installation paths between the installation components and sequences.

In step S15, multi-language files are derived for installations.

Usually, as described, software installation uses specified installation components, designed using software distributions, such as InstallShield, DemoShield, or others. It is time-consuming to design exclusive installation components for each application, resulting in redundant code and wasting system resources.

### SUMMARY

Methods for integrating software distribution are provided. In an embodiment of such a method, a main execution file and a plurality of shared distribution systems are packaged as a main installation program. The main installation program accesses an installation configuration file, registering the number of installation components and installation sequences corresponding to each installation component. The main installation program installs the shared distribution and a component execution file in an installation component according to one installation sequence.

### DESCRIPTION OF THE DRAWINGS

Methods and systems for integrating software distribution can be more fully understood by reading the subsequent detailed description and examples with references made to the accompanying drawings, wherein:

FIG. 1 is a flowchart of a design process for software installation;

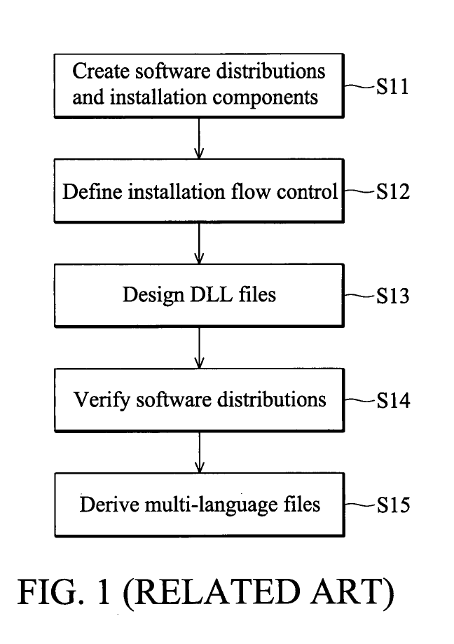

FIG. 2 is a schematic diagram of an embodiment of a system for integrating software distribution; and

FIG. 3 is a flowchart of an embodiment of a method for integrating software distribution.

### DETAILED DESCRIPTION

Embodiments of the invention disclose methods and systems for integrating software distribution.

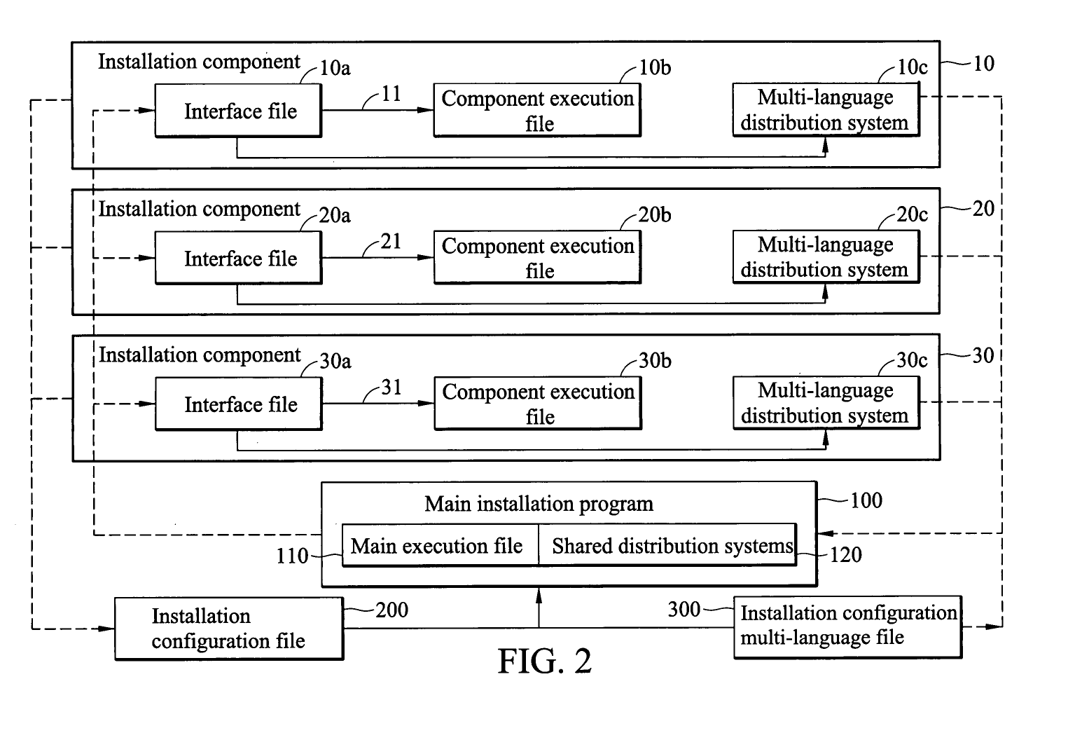

FIG. 2 is a schematic diagram of an embodiment of a system for integrating software distribution, comprising a main installation program 100, an installation configuration file 200, an installation configuration multi-language file 300, and a plurality of installation components (comprising 10, 20, and 30 in this embodiment of the invention). Each installation component comprises an interface file (10a, 20a, or 30a) and a component execution file (10b, 20b, or 30b), and a multi-language distribution system (10c, 20c, or 30c).

Main installation program 100 further comprises a main execution file 110 and shared distribution systems 120 required for software installation. A dynamic link library file (for example, MSVCRT.dll) must be pre-disposed in main installation program 100 if the file is required for software installation. Additionally, each shared distribution system is installed using a fixed installation sequence, non-modifiable during normal installation to provide a secure and stable system.

Installation configuration file 200 registers the number, unlimited, of the installation components supported by main installation program 100 and installation sequences corresponding to installation components 10, 20, and 30. Each installation sequence corresponding to each installation component is predefined, such that main installation program 100 implements software installation accordingly.

Installation configuration multi-language file 300 registers multi-language settings and multi-language installation sequences applied to each installation component. Main installation program 100 implements multi-language installations in accordance with installation configuration multi-language file 300.

Interface files are communication interfaces between main installation program 100 and component execution files of installation components. Main installation program 100 executes a component execution file according to contents, features, and installation sequences thereof. In the following, details of an embodiment of the system for integrating software distribution are described, in which installation component 10 is used as an example.

Main installation program 100 first accesses installation configuration file 200 using main execution file 110 and determines installation component 10 for software installation accordingly. Next, main installation program 100 access installation sequences for installation component 10 in installation configuration file 200. Next, main installation program 100 installs shared distribution systems 120 and component execution file 10b in accordance with installation configuration file 200 and interface file 10a. Further, if multi-language support is required, main installation program 100 installs multi-language distribution system 10c according to installation configuration multi-language file 300.

Installation components of embodiments of the invention can further support firmware installation for different types of firmware devices, comprising storage devices, network equipments, hardware input devices, and others.

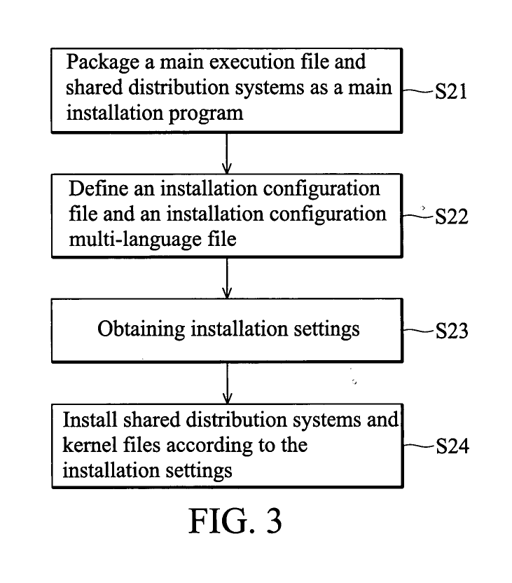

FIG. 3 is a flowchart of an embodiment of a method for integrating software distribution.

First, a main execution file and a plurality of shared distribution systems are packaged as a main installation program (step S21), and an installation configuration file and an installation configuration multi-language file are defined (step S22). The main installation program accesses the installation configuration file and the installation configuration multi-language file, obtaining installation settings thereof (step S23). The main installation program installs shared distribution systems and kernel files in an installation component according to the installation settings (step S24).

Embodiments of the invention integrate software distribution, without requiring redundant shared distribution systems, saving time for software development and system resources.

Although the present invention has been described in preferred embodiment, it is not intended to limit the invention thereto. Those who are skilled in this technology can still make various alterations and modifications without departing from the scope and spirit of this invention. Therefore, the scope of the present invention shall be defined and protected by the following claims and their equivalents.

What is claimed is:

1. A method for integrating software distribution, comprising:
packaging a main execution file and a plurality of shared distribution systems as a main installation program;
the main installation program accessing an installation configuration file, registering the number of installation components and installation sequences corresponding to each installation component; and
the main installation program installing the shared distribution systems and a component execution file in an installation component according to one installation sequence.

2. The method for integrating software distribution as claimed in claim 1, further comprising the main installation program accessing an installation configuration multi-language file and installing a multi-language distribution in the installation component according to a multi-language installation sequence in the installation configuration multi-language file.

3. The method for integrating software distribution as claimed in claim 1, wherein the main execution file installs the component execution file according to an interface file in the installation component.

4. The method for integrating software distribution as claimed in claim 3, wherein the interface command defines contents, features, and installation sequences of the component execution file.

5. The method for integrating software distribution as claimed in claim 4, wherein the component execution file comprises a plurality of executable files, drivers, and dynamic link library files.

6. A system for integrating software distribution, comprising:
at least one installation component, comprising an interface file and a component execution file;
an installation configuration file, registering the number of the installation components and installation sequences corresponding to each installation component; and
a main installation program, comprising a main execution file and a plurality of shared distribution systems, installing the shared distribution systems and the component execution file according to one installation sequence.

7. The system for integrating software distribution as claimed in claim 6, further comprising an installation configuration multi-language file, accessed by the main installation program to install a multi-language distribution system in the installation component according to a multi-language installation sequence in the installation configuration multi-language file.

8. The system for integrating software distribution as claimed in claim 6, wherein the main execution file installs the component execution file according to an interface file in the installation component.

9. The system for integrating software distribution as claimed in claim 8, wherein the interface command defines contents, features, and installation sequences of the component execution file.

10. The system for integrating software distribution as claimed in claim 9, wherein the component execution file comprises a plurality of executable files, drivers, and dynamic link library files.
